(19) United States
(12) Patent Application Publication
(10) Pub. No.: US 2012/0199392 A1
(43) Pub. Date: Aug. 9, 2012

(54) MULTI-CONDUCTOR SPLICE CARRIER

(75) Inventors: Marc N. Samuelson, Houston, TX (US); Todd C. Jackson, Houston, TX (US); David E. Schneider, Conroe, TX (US)

(73) Assignee: BAKER HUGHES INCORPORATED, Houston, TX (US)

(21) Appl. No.: 13/023,590

(22) Filed: Feb. 9, 2011

(51) Int. Cl. H01R 4/00

(52) U.S. Cl. 174/88 R

(57) ABSTRACT

A splice carrier has a first end and a second end and a sleeve portion located at the first end. The splice carrier also includes a body portion extending between the first end and the second end and including one or more grooves disposed therein. The one of the grooves includes a receiving area configured to receive a mechanical splice.

### BACKGROUND

It is not uncommon to have to splice several devices requiring a supply of electrical energy serially into a single power line. The same is true for communication lines. In some cases, a multi-conductor control line includes both power and communication conductors. The individual conductors are all surrounded by a casing that is made of metal or another material. The casing serves to protect the conductors when they are utilized in a harsh environment such as, for example, a downhole environment related to the production of petrochemicals or Carbon Dioxide sequestration.

To splice a device into such a control line, the control line is first cut. Then, the individual conductors of the control line on both sides of the cut are exposed and electrically coupled to corresponding input and output conductors (leads) of the device. The conductors are typically coupled by mechanical splicing devices (crimps). The mechanical splicing devices are typically pushed into the device. The control line and the device are then sealed together to ensure that environmental factors do not affect the operation of the device.

### SUMMARY

According to one embodiment, a splice carrier having a first end and a second end is disclosed. In this embodiment, the splice carrier includes a sleeve portion located at the first end and a body portion extending between the first end and the second end. The body portion of this embodiment includes one or more grooves disposed therein and one of the one or more grooves includes a receiving area configured to receive a mechanical splice.

According to another embodiment a system including a control line including an outer casing surrounding a plurality of conductors and a splice carrier having a sleeve portion disposed at least partially within the outer casing is disclosed. The splice carrier includes a body portion extending between the first end and the second end. The body portion includes one or more grooves disposed and one of the one or more grooves includes a receiving area configured to receive a mechanical splice.

### BRIEF DESCRIPTION OF THE DRAWINGS

Referring now to the drawings wherein like elements are numbered alike in the several Figures:

FIG. 1 is a representation of a system according to one embodiment of the present invention;

FIG. 2 is a perspective view of a splice carrier according to one embodiment;

FIG. 3 is a close up perspective view of one end of the splice carrier shown in FIG. 2; and

FIGS. 4A and 4B illustrate alternative embodiments of a collar region that may be part of a splice carrier.

### DETAILED DESCRIPTION

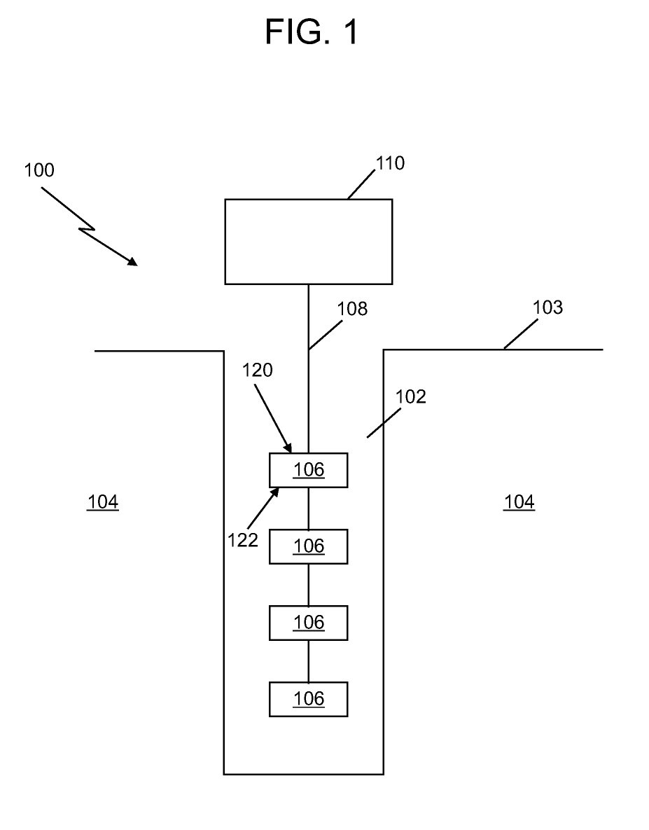

FIG. 1 shows an operating environment 100 in which embodiments of the present invention may be utilized. The operating environment 100, generally, is shown as a petrochemical production environment where a borehole 102 is drilled into and penetrates the surface 103 of the earth 104. Of course, the operating environment 100 is presented by way of example only and in no way is meant to limit the invention disclosed herein unless such limitation is specifically recited.

One or more devices 106 are typically lowered down into the borehole 102 and are serially connected to a control line 108. Of course, the devices 106 could be deployed in the borehole 102 utilizing, for example, tubing joints attached to a wellhead tubing hanger (not illustrated). In some instances, the control line 108 includes conductors that allow power to be transmitted from a surface unit 110 to the devices 106. In addition, the control line 108 can also include conductors that allow for communication between the surface unit 110 and the devices 106. It shall be understood that the teachings herein can be applied to any type of conductors including, but not limited to, wires, cables, and photonic transmission mediums such as fiber optic cable and the like.

Conditions in the borehole 102 are harsh. Accordingly, the control line 108 can include both power and communication conductors as described above. In such a case, the control line 108 can include an outer metal casing that surrounds all of the conductors of the control line 108.

As shown, the control line 108 has the devices 106 serially displaced along it length. Accordingly, the control line 108 has been spliced to both the input side 120 and the output side 122 of one of the devices 106 in this example. For each splice, the control line 108 was cut and the conductors within it electrically coupled to leads on the input side 120 and the output side 120 of the devices 106. Typically the conductors and the leads are spliced together by utilizing mechanical splicing devices. An example of a mechanical splicing device is a so-called “crimp.” A crimp is typically a cylindrical element that can receive a conductor in both ends. The crimp is then crushed with pliers or other implements to both mechanically and electrically join the two conductors together. The joined conductors and leads are then, typically, forced into the devices 106 and the control line 108 is physically connected to the device 106 in a sealed manner.

As discussed above, the control line 108 can include an outer metal casing. This outer metal casing can have sharp edges that can damage the conductors within the control line 108. In addition, is has been discovered that it is at times difficult to force multiple spliced conductors into the devices 106. In addition, unless wrapped in electrical tape or other isolation means, exposed portions of the conductors/leads may exist in the area of the mechanical splicing device. These exposed portions can lead to shorts or other unfavorable conditions if they contact other exposed portions, the outer metal casing of the control line 108 or the body of the device.

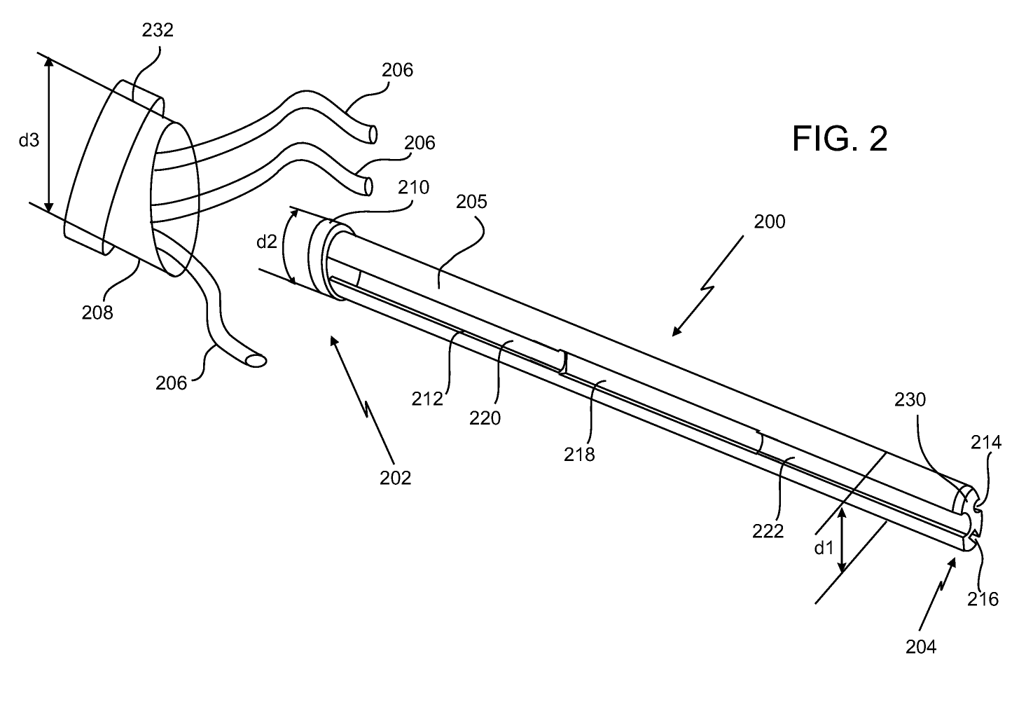

FIG. 2 shows a perspective view of a splice carrier 200 according to an embodiment of the present invention is illustrated. The splice carrier 200 includes a first end 202 and a second end 204 separated by a body portion 205. The first end 202 is configured to mate or otherwise contact the control line 108.

The illustrated control line 108 includes a plurality of conductors 206. The conductors 206 are incased within and extend out from an outer casing 208. The outer casing 208 is typically formed of at least metal and may also include other protecting layers formed of, for example, rubber or plastic or a combination thereof.

In one embodiment, the first end 202 includes a collar portion 210. The collar portion 210, as discussed in greater detail below, is a hollow receiving ring that mates with the outer casing 208 to protect the conductors 206 from any sharp edges on the outer casing 208.

The body portion 205 has a width illustrated as diameter d₁. Of course, the body portion need not be cylindrical as illustrated in FIG. 1. The collar portion 210 has an outer diameter d₂. In one embodiment, d₂ is greater than d₁. As illustrated, the control line 108 has a diameter d₃. It shall be understood that d₃ is the inner diameter of the outer casing 208 in one embodiment. In one embodiment, d₃ is greater than d₂.

The body portion 205 includes one or more grooves 212, 214, 216 that extend generally from the first end 202 to the second end 204. In the illustrated embodiment, the grooves 212, 214 and 216 extend from the sleeve portion 210 to the second end. As illustrated, the body portion 205 includes three grooves 212, 214, 216. However, the body portion 205 could include more or less than three grooves in alternative embodiments. Typically, the number of grooves provided in the portion 205 will be the same as the number of conductors 206 in the control line 108. The grooves 212, 214, 216 are each shaped and configured to receive a conductor 206.

In one embodiment, the grooves 212, 214, 216 include an expanded region 218. The expanded region 218 is sized and configured to receive a mechanical splicing device (not shown) in one embodiments and is larger than other portions of the groove in which it resides. To that end, one or more of the grooves 212, 214, 216 include a first groove portion 220 on one side of the expanded region 218 and a second groove portion 222 on the other side of the expanded region 218.

In one embodiment, a conductor from a device (not shown) is spliced to one of the conductors 206 with a mechanical splicing device. The conductor 206 is retained in the first groove portion 220, the conductor from the device is retained in the second groove portion 212 and the mechanical splicing device is retained in the expanded region 218. It shall be understood that the conductor 206 passes through the sleeve portion 210 at the first end 202. The entire assembly including the conductors 206, the mechanical splices and the body portion 205 may then be inserted into the device. To aid in such an insertion, in one embodiment, the splice carrier 200 includes a tapered region 230 that tapers inwardly from the body portion 205 to the second end 204.

As discussed above, in one embodiment, the diameter d₂ of the collar portion 210 is less than or equal to both the inner and outer diameter of the control line 108. In this manner, a standard metal-to-metal sealing jam nut 232 sized for the control line 108 may be utilized to seal the control line 108 to a device without introducing multiple larger diameter seals and adding more possible failure points due to leaks.

It shall be understood that each groove 212, 214, 216 includes a separate receiving area 218 that begins a particular distance away from the first end 202. In one embodiment, the receiving area 218 for each groove begins at a different distance away from the first end 202. In this manner, the mechanical splicing devices that are ultimately inserted in the receiving areas are staggered along the length of the splice carrier 200.

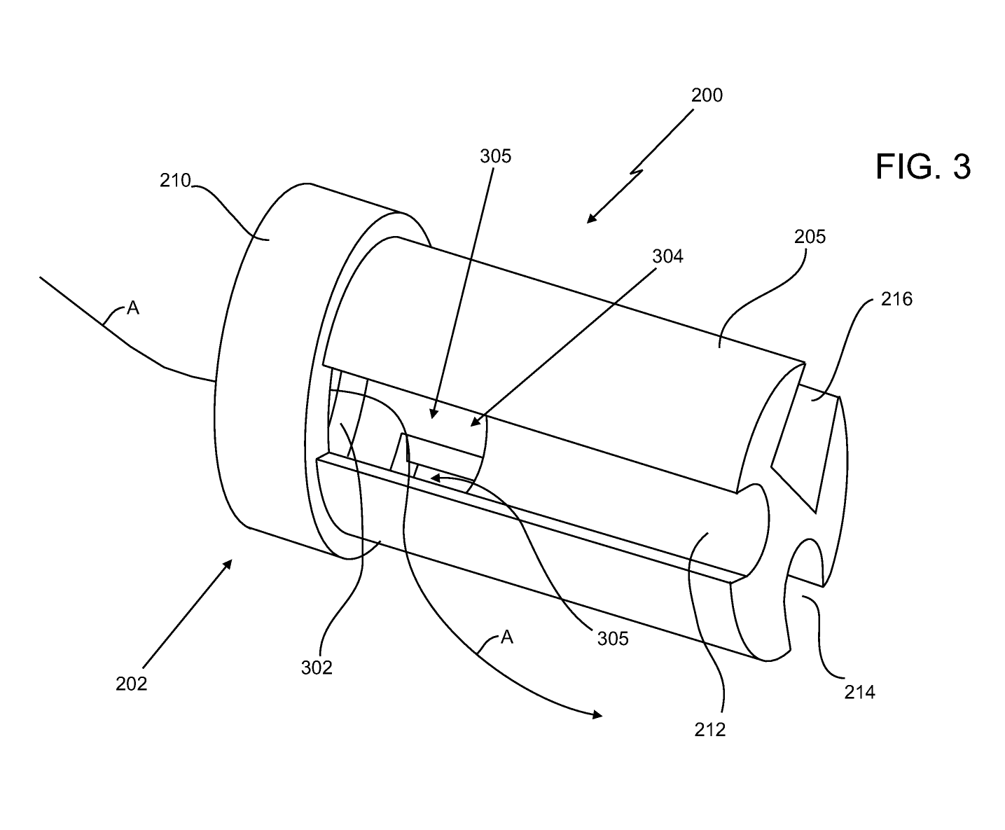

FIG. 3 is a close-up view perspective view of the region near the first end 202 of the splice carrier 200. The collar portion 210 includes an opening 302. The opening 302 opens into a receiving area 304 in the body portion 205. In one embodiment, the receiving area 304 is a hollow region of the body portion 205 and includes outlets 305. A conductor (not shown) may be introduced into the collar portion 210 from the first end 202 such that an end of the conductor enters the receiving area 304. The conductor can then be removed from the receiving area 304 through outlet 305 as indicated by arrow A. As illustrated, the receiving area extends from the sleeve portion 210 to the beginning of the grooves 212, 214, 216. Of course, the depth of the receiving area 304 may be varied depending on the context.

In use, the collar portion 210 is inserted into or otherwise mated to a control line in the region the control line was cut and protects the conductors from sharp edges due to the cut. The receiving area 304 allows the conductors to be routed to and retained in one of the grooves 212, 214, 216 in the body portion 205 of the splice carrier 200. Of course, in one embodiment, the collar portion 210 could be arranged to surround the control line and establish either a slip or interference fit.

It shall be appreciated that the cross-sectional shape of the grooves 212, 214, 216 can be selected to hold or otherwise retain conductors of particular shapes or sizes and are selected based on conductors the splice carrier 200 is to interact with. It shall also be understood that in one embodiment, the splice carrier 200 can be encased in a non-conductive outer sleeve (not illustrated) to prevent shorts from the conductors it carries to the body of the any the devices 106 (FIG. 1) into which it may be inserted.

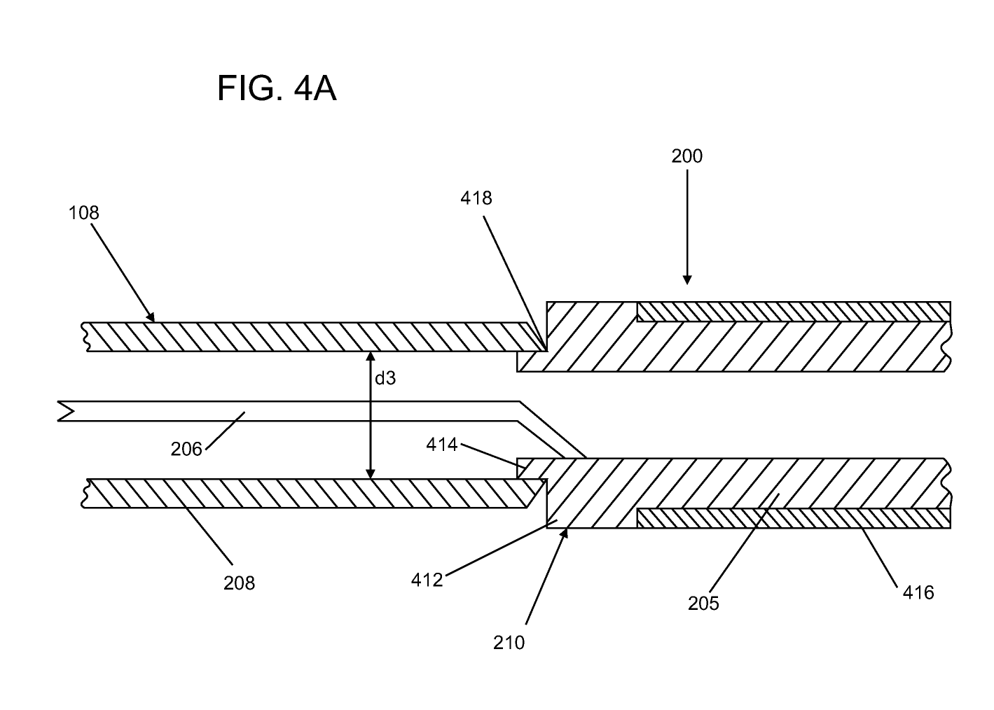

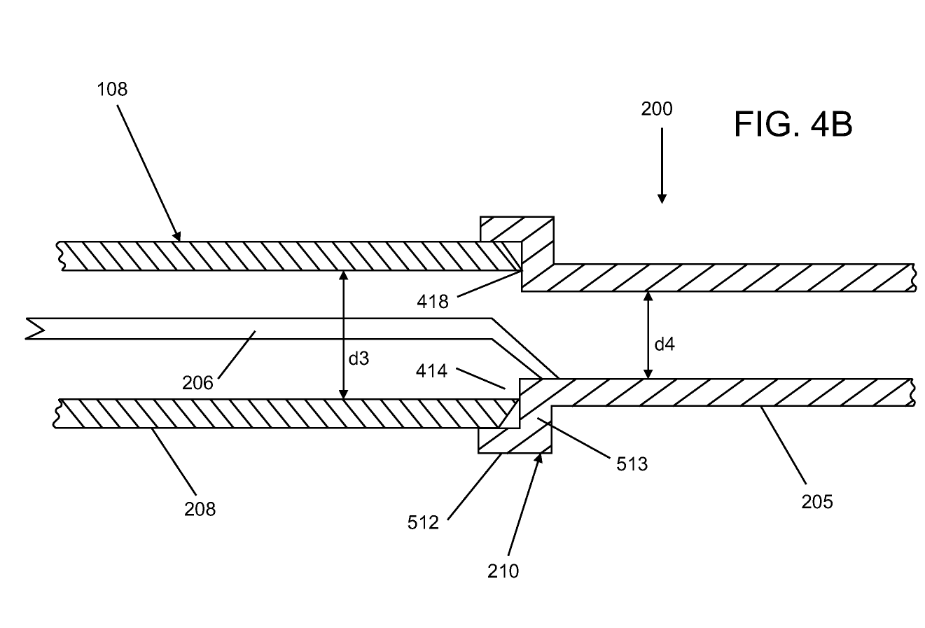

It shall be appreciated that the collar portion 210 shown above is illustrative. Indeed, embodiments of the present invention can employ other collar portion 210 configurations. For example, and referring now to FIG. 4A, a cut-away side view of a collar portion 210 according to an embodiment of the present invention is illustrated joined to a control line 108.

In this embodiment, the collar portion 210 includes an external collar region 412. The external collar region 412 extends at least from the inner diameter d₃ of the outer casing 208 to a larger diameter. The collar portion 210 also includes an internal collar region 414. The internal collar region 414 fits inside the inner diameter d₃ and protects the conductor 206 from any sharp edges that may exist in the cut region 418 where the outer casing 208 was cut. In addition, as shown in the FIG. 4A, an insulating sleeve 416 is shown covering the body 205 of the splice carrier 200. The insulating sleeve 416 could be used in combination with any embodiment disclosed herein or later developed.

FIG. 4B shows a cut-away side view of a collar portion 210 according to another embodiment of the present invention joined to a control line 108. In this embodiment, the collar portion 210 includes an outer ledge 512 sized and configured to surround the outer casing 208. The collar portion 210 also includes a translation region 513 that decreases an inner diameter of the splice carrier 200 to the internal diameter d₄ that is less than the inner diameter d₃ of the outer casing 208. In this manner, the collar portion 210 protects the conductor 206 from any sharp edges that may exist in the cut region 418 where the outer casing 208 was cut.

While preferred embodiments have been shown and described, modifications and substitutions may be made thereto without departing from the spirit and scope of the invention. Accordingly, it is to be understood that the present invention has been described by way of illustrations and not limitation.

1. A splice carrier having a first end and a second end, the splice carrier comprising:
a sleeve portion located at the first end;
a body portion extending between the first end and the second end, the body portion including one or more grooves disposed therein, wherein one of the one or more grooves includes a receiving area configured to receive a mechanical splice.

2. The splice carrier of claim 1, wherein the body portion has a first diameter and the sleeve portion has a second diameter greater than the first diameter.

3. The splice carrier of claim 1, wherein the body portion include a receiving area adjacent to the sleeve portion.

4. The splice carrier of claim 1, wherein the receiving area provides access to the one more grooves from the sleeve portion.

5. The splice carrier of claim 1, wherein one or more of the one or more grooves includes an expanded region.

6. The splice carrier of claim 1, wherein the one or more grooves includes a first groove including in a first expanded region, a second groove including a second expanded region and a third groove including a third expanded region.

7. The splice carrier of claim 6, wherein the first expanded region begins at first distance from the sleeve portion, the second expanded region begins at a second distance from the sleeve portion, the third expanded region begins at a third distance from the sleeve portion and wherein first, second and third distances are different from each other.

8. The splice carrier of claim 6, wherein the first expanded portion separates the first groove into a first groove portion and a second groove portion.

9. The splice carrier of claim 8, wherein the first groove portion is configured to receive a conductor from a control line and the second groove portion is configured to receive a lead from a device.

10. The splice carrier of claim 9, wherein the mechanical splice electrically couples the conductor and the lead first.

11. A system comprising:
a control line including an outer casing surrounding a plurality of conductors;
a splice carrier having a sleeve portion disposed at least partially within the outer casing, the splice carrier including:
a body portion extending between the first end and the second end, the body portion including one or more grooves disposed therein, wherein one of the one or more grooves includes a receiving area configured to receive a mechanical splice.

12. The system of claim 11, wherein the body portion has a first diameter and the sleeve portion has a second diameter greater than the first diameter.

13. The system of claim 12, wherein the control line has a third diameter, the third diameter being greater than the second diameter.

14. The system of claim 11, wherein the body portion includes a receiving area adjacent to the sleeve portion.

15. The system of claim 11, wherein at least one of the plurality of conductors passes though the sleeve portion and is disposed within one of the one or more grooves.

16. The system of clam 11, further comprising:
the mechanical splice disposed within the receiving area.

17. The system of claim 16, further comprising:
a device having an electrical lead;
wherein the mechanical splice electrically coupled the electrical lead to one of the plurality of conductors.

18. The system of claim 17, wherein the splice carrier is disposed within the device.
